(19) United States
(12) Patent Application Publication
(10) Pub. No.: US 2024/0205572 A1
(43) Pub. Date: Jun. 20, 2024

(54) SOFTWARE DEFINED OPTICAL NETWORK CONTROLLER DEPLOYMENT METHOD BASED ON MULTI PATH SURVIVABILITY PROTECTION

(71) Applicant: CHONGQING UNIVERSITY OF POSTS AND TELECOMMUNICATIONS, Chongqing (CN)

(72) Inventors: Shuai Zeng, Chongqing (CN); An Lin, Chongqing (CN); Wenqiang Tang, Chongqing (CN)

(21) Appl. No.: 17/791,919

(22) PCT Filed: Nov. 30, 2021
(86) PCT No.: PCT/CN2021/134463

§ 371 Date: Jul. 11, 2022

(30) Foreign Application Priority Data
Jun. 22, 2021 (CN) CN20110691229.4

(51) Int. Cl. H04Q 11/00

(52) U.S. Cl. CPC H04Q 11/0062; H04Q 2011/0081

(57) ABSTRACT

The present invention relates to a software defined optical network controller deployment method based on multi-path survivability protection, and belongs to the technical field of networks, which is applied to the deployment of layer 2 SDN controllers. On the premise of ensuring the requirements of users for the survivability of the control plane, a multi-controller multi-path cooperative control of switching nodes is proposed to further reduce the number of controllers and control the cost. The present invention first works out a controller deployment scheme with a unique link between switches and controllers. The scheme contains redundant controllers, and the number of controllers needs to be further reduced. The present invention verifies whether the fault probability of each switch is lower than that required by the user by adopting the posteriori thought, that is, according to the deployment result. The number of controllers is gradually reduced, and the survival probability of the switches is always ensured until the deployment number of controllers is minimized. Finally, a controller with minimum communication time delay is selected as a control center to complete the deployment of the entire control plane.

### FIELD OF INVENTION

The present invention belongs to the multi-path survivability design part of a control plane in a software-defined optical network and particularly relates to a deployment method of layer 2 SDN controllers combining regional control and centralized control in the control plane.

### BACKGROUND ART OF THE INVENTION

With the rapid growth of IP services, people propose higher and higher demands for network bandwidth and more and more urgent dynamic allocation demands for network bandwidth. Therefore, with powerful transmission capacity, the optical network plays an increasingly important role in modern information technology.

The Software Defined Optical Network (SDON) is a specific application of the Software Defined Network (SDN) at the level of intelligent optical network control, where the optical network is divided into a data plane and a control plane. The data plane is specially used for forwarding of service traffic, and the control plane mainly comprises providing unified scheduling and control capabilities for various optical layer resources by controllers driven by software programming so as to realize dynamic control on the optical network with huge data traffic.

The SDON control plane carries the core service of the entire network. Once the control plane is disconnected from the data plane, the data plane will lose the data forwarding capability on a large scale. Therefore, the primary goal of the normal operation of the control plane is to ensure the survivability of the control plane. Meanwhile, reducing the control redundancy of the control plane and shortening the communication time delay also play an important role in the overall performance of the network.

Therefore, the reasonableness of the deployment position of the controllers plays a key role in ensuring the survivability of the control plane. At present, a lot of researches on the controller deployment method already exist, for example, literature [1] Xiong Yu, Dong Xiancun, Li Yuanyuan, Lu Yi, Wang Ruyan, The Cross-layer Survivable Design of Control Plane Based on Minimum Point Covering in Software Defined Optical Network [J], Journal of Electronics & Information Technology, 2016,38(05):1211-1218, proposes a survivable design strategy of a control plane based on minimum point covering, establishes a hierarchical control model and sets different levels of controllers, which avoids the over-reliance on a single controller and the conflict of different controllers, but the method cannot change the controller deployment scheme according to the requirements of users for time delay. To solve the problem, literature [2] Zeng Shuai, Gai Shaocong, Zhang Yi, Zhao Guofeng, Zuo Lizheng, Survivability Deployment Method for Controller with Time-delay Constraint in Software Defined Optical Network [J], Journal of Electronics & Information Technology, 2017,39(07):1727-1734, proposes a deployment method for controllers with time-delay constraint, which takes full account of factors such as time delay, survivability and controller redundancy, but the method cannot meet the requirements of users for the survivability of the control plane. Further, literature [3] Zeng Shuai, Qian Zhihua, Zhao Tianfeng, Ren Yan, Wang Yujie, Software Defined Optical Network Controller Deployment Algorithm Constrained by Survivability Conditions [J], Journal of Electronics & Information Technology, 2020,42(10):2412-2419, proposes a controller deployment scheme constrained by survivability conditions, which effectively reduces time delay on the premise of ensuring the survivability of the control plane, but the method does not take account of the cooperative control on network nodes by multiple controllers, which fails to effectively reduce the control redundancy of the control plane and still has room for further optimization.

In view of the above defects of the prior art, considering that network nodes are cooperatively controlled by multiple controllers, the multiple controllers are used for multi-path survivability protection of the forwarding device, so as to improve the overall invulnerability of the system and reduce the control time delay. Compared with the traditional one-to-one control links, the multi-path multi-controller control mode not only ensures the survivability requirements of the users, but also greatly reduces the deployment cost of controllers and the communication time delay of the control plane, and thus is a more efficient and reasonable controller deployment method.

### DISCLOSURE OF THE INVENTION

The present invention aims to solve the above problems of the prior art. A software defined optical network controller deployment method based on multi-path survivability protection is proposed. The present invention has the following technical solution:

A software defined optical network controller deployment method based on multi-path survivability protection, comprising the following steps:
Step 1: calculating the length W of the longest control link under a single controller according to the probability P specified by a user to ensure the survivability of network topology;
Step 2: calculating the shortest path Lᵢⱼ between switches V by using the Floyd algorithm, taking Lᵢⱼ as the weight of connection between Vᵢ and Vⱼ, and converting SDON network topology to a complete bipartite graph; and deleting any link with Lᵢⱼ>W, ensuring that the length of each feasible path is less than W, and forming a new bipartite graph G;
Step 3: reconverting G to network topology, distributing switches with feasible paths to the same area, wherein the topology is usually divided into n areas, and a switch in the i^{th} area is represented by φᵢ, and forming different areas into a set {φ₁, φ₂, . . . , φₙ}. Then calculating a set {θᵢ₁, θᵢ₂, . . . , θᵢₙ} of optimal minimal dominating sets in φᵢ, wherein n represents the number of switches in the minimal dominating set. The deployment position of the optimal minimal dominating set is the deployment scheme of a single controller, and a deployment scheme containing redundant controllers is obtained and represented by a set {C₁, C₂, . . . , Cₙ};
Step 4: reordering controllers in the set {C₁, C₂, . . . , Cₙ} from small to large based on the number of switches under respective control to obtain a new set {C′₁, C′₂, . . . , C′ₙ}, and trying to delete the controller C′₁;
Step 5: when C′₁ is no longer used as a controller, representing isolated switches by a set {S₁, S₂, . . . , Sₙ}; and finding k (k≥2) new control links for Si by using the Floyd algorithm, wherein the Floyd algorithm is used for finding the shortest path from Sᵢ to other nodes, and appropriate control links and the number thereof are selected so that the network fault probability meets the survivability requirement;
Step 6: judging whether Sᵢ can achieve the network survivability after being linked to a new controller by using the calculation formula of the network fault probability under multiple controllers; if all switches in the set {S₁, S₂, . . . , Sₙ} find satisfactory controllers and control links, the controller C′₁ can be deleted, and the new controller is added to a set {V_{pc1}, V_{pc2}, . . . , V_{pcn}}; otherwise, C′₁ cannot be deleted, and C′₁ is added to the set {V_{pc1}, V_{pc2}, . . . , V_{pcn}};
Step 7: after operation (it is inappropriate to discuss this term) of C′₁, repeating steps 4, 5 and 6 until the operation of all controllers in the {C′₁, C′₂, . . . , C′ₙ} is completed, and the set {V_{pc1}, V_{pc2}, . . . , V_{pcn}} is an SDON controller deployment scheme based on multi-path survivability protection;
Step 8: determining the deployment position of the control center V_{cc} based on coordinated signaling transmission time delay between the controllers.

Further, the step of calculating the shortest path Lᵢⱼ between switches V by using the Floyd Shortest Path Algorithm in step 2 specifically comprises: representing the shortest distance between Vᵢ and Vⱼ by M[i, j], wherein k is a possible intermediate point between i and j, updating the entire matrix, i.e., the path length from i to j, and when the intermediate point is k, traversing all the possible intermediate points to obtain a globally optimal shortest path.

Further, the calculation formula of the length of the longest control link is:

$$W = \frac{ln ( 1 - P )}{ln ( 1 - ρ )} ,$$

the maximum length L of the control link is calculated, wherein P is the maximum fault probability acceptable to the user, and p is the fault probability per 100 km of optical fibers; and then SDN switch nodes are abstracted into a complete bipartite graph, the minimum path length between the nodes is taken as the weight of the bipartite graph, links with the weight larger than L are deleted from the bipartite graph, reachable nodes in the bipartite graph are distributed to the same area, and network topology is reconverted.

Further, the conditions for determining the optimal minimal dominating set in step 3 are as follows: the minimal dominating set with the smallest number of nodes is selected as the optimal minimal dominance set in the area to reduce the deployment cost of controllers; and if multiple satisfactory minimal dominating sets exist, a minimal dominating set with the largest sum of degrees of the nodes in the set, thereby improving the control redundancy of the control plane while minimizing the deployment cost.

Further, in step 4, the currently optimal set {C₁, C₂, . . . , Cₙ} ordering method is selected by referring to the greedy algorithm; the number of switches controlled by controllers is taken as the evaluation criteria; wherein the controllers controlling less switches have less impact on the control plane if deleted, are easier to delete, and thus are ranked ahead; and therefore, the sets are reordered from small to large based on the number of switches controlled by the controllers to obtain a set {C′₁, C′₂, . . . , C′ₙ}.

Further, in step 5, no redundancy protection path is considered between switches and controllers, i.e., only one control path exist; and the corrected Floyd algorithm is used for finding N controllers for Sᵢ, and control links between the N controllers and Sᵢ do not have multiple edges.

Further, in step 6, the network fault probability of the control plane of switches under multiple controllers is calculated according to formula (1), wherein P′ represents the fault probability after an isolated switch node Sᵢ is connected to a new controller, a set {L₁, L₂, . . . , Lₙ} represents the length of control links not having multiple edges between Sᵢ and the N controllers, and Lᵢ represents the length of the i^{th} control link. According to the formula, it can be considered that Sᵢ can achieve the survivability required by the user after being connected to the new controller so long as P′<P;

P′=Πᵢ₌₁ⁿ[1−(1−ρ)^{L}^{ᵢ}] (1)

Further, in step 8, in consideration of coordinated signaling transmission time delay between the controllers, the V_{cc} node is deployed at the node Tₘᵢₙ=min{T₁, T₂, . . . , T₃} with minimum average interaction time delay to the controller deployment node, wherein T(Vᵢ, Vⱼ) represents interaction time delay between nodes Vᵢ and Vⱼ, and Tᵢ represents average interaction time delay between Vᵢ and other nodes;

Tᵢ=avgΣⱼ₌₁ⁿ⁻¹T(Vᵢ,Vⱼ) (2)

The present invention has the following advantages and beneficial effects:

In previous researches, the switch nodes are only managed by only one controller and have only one control link. In this way, the link fault probability and the link length are easily converted, but if the link fails, the control plane cannot work properly. The present invention considers that the switch nodes are under the cooperative control of multiple controllers at the same time, and the switches can still work normally so long as the links between the switches and the controllers do not fail at the same time, so the fault probability of the control plane can be greatly reduced.

Compared with the previous single-path controller deployment algorithm, the algorithm based on multi-path survivability protection significantly reduces the deployment number of controllers and the deployment cost of the control plane on the premise of ensuring the survivability requirements of the control plane. However, the mathematical relationship between the fault probability of the control plane and the control link of the algorithm based on multi-path survivability protection is complex, and the control link and the fault probability are difficult to convert. The present invention innovatively works out a regional controller deployment scheme with a unique link between switches and controllers first, thus obtaining a deployment scheme containing redundant controllers. Then the number of controllers is gradually reduced to minimize the number of controllers, finally obtaining the controller deployment scheme based on multi-path survivability protection.

During the process of reducing the number of controllers, the survivability requirement of the control plane is always ensured. The present invention calculates the current fault probability of the control plane according to the formula P′=Πᵢ₌₁ⁿ[1−(1−ρ)^{L}^{ᵢ}] by adopting the posteriori thought, i.e., based on the deployment result, and ensures that the current fault probability is lower than the network fault alarm probability specified by the user. On the premise of meeting the survivability requirement, the number of controllers is reduced, thus obtaining an optimal control deployment scheme.

In step 4, after the deployment scheme of the controller with a single control link is worked out, the deletion order of the controllers will affect the final number of controllers and the control links. When reducing the deployment cost of the controllers is taken as the primary goal, the most desirable deployment scheme is centralized control on switches by very few controllers. The number of control links is maximized, and the number of controllers is reduced. To achieve the above results, the number M of switches controlled by the controllers is taken as the evaluation criteria in the present invention. The controllers with smaller M have minimum impact on the control plane if deleted, i.e., most likely to be deleted. Therefore, the deletion order of the controllers is an ascending order of M.

In step 6, when an isolated switch tries to connect to new controllers, the connection order of the switch and the controllers also affect the final deployment scheme. To minimize the number of controllers and reduce the deployment cost, the switch shall tend to be connected to a controller with a larger M value. Supposing that the switch S needs to be connected to three controllers to meet the survivability requirements. The switch S is first connected to the currently available controller with the maximum M value. After the first controller is connected, the control link between the second controller and the switch S shall not have multiple edges with the first control link, and the M value shall be as large as possible. The above method is repeated for the third controller.

In step 5, when control links without multiple edges are found, the present invention modifies the Floyd algorithm. After a feasible path is found, the weight of the path is set to be infinite to ensure that the subsequent control paths and the previous paths do not duplicate links, and the shortest single-point multi-source path without multiple edges is worked out.

In step 7, after a redundant controller C is deleted successfully, the controller C becomes a switch and is distributed to a set of other isolated switches. To ensure the survivability, the switch must be connected to new controllers, and the network topology changes certainly. After a controller is judged to be successfully deleted, it is necessary to record the deleted controller to ensure that the subsequent isolated switches are connected to the working switches. Meanwhile, the M value of controllers needs to be updated so that the switches are controlled by as few controllers as possible.

### DESCRIPTION OF THE DRAWINGS

FIG. 1 shows a deployment model applied by the present invention for providing preferred embodiments;

FIG. 2 is a deployment flow chart of the present invention.

### DETAILED DESCRIPTION OF THE INVENTION

The technical solution in the embodiments of the present invention will be clearly described in detail below in combination with the drawings in the embodiments of the present invention. The described embodiments are merely part of the embodiments of the present invention.

To solve the above problems, the present invention adopts the following technical solution:

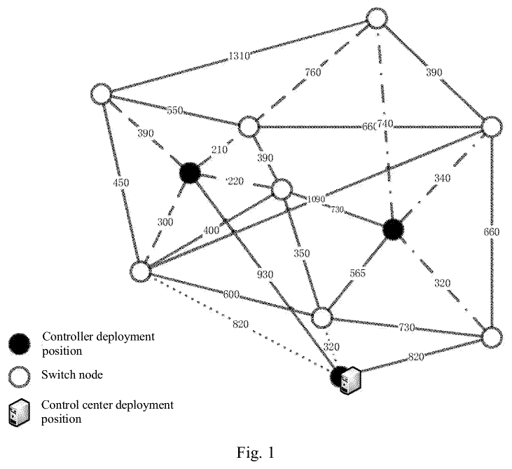

FIG. 1 is a diagram of a controller deployment model based on multi-path survivability protection applied by the present invention, and different lines represent control links of different controllers. The SDN switch in FIG. 1 is jointly controlled by one or more controllers. The survivability of the control plane can be ensured so long as the SDN switch does not lose contact with all connected controllers, and the deployment position of the control center depends on the position of the controller with minimum communication time delay among the controllers. In the deployment scheme, the maximum fault probability acceptable to the user is 0.1, and the fault probability per 100 km of optical fibers is 0.03.

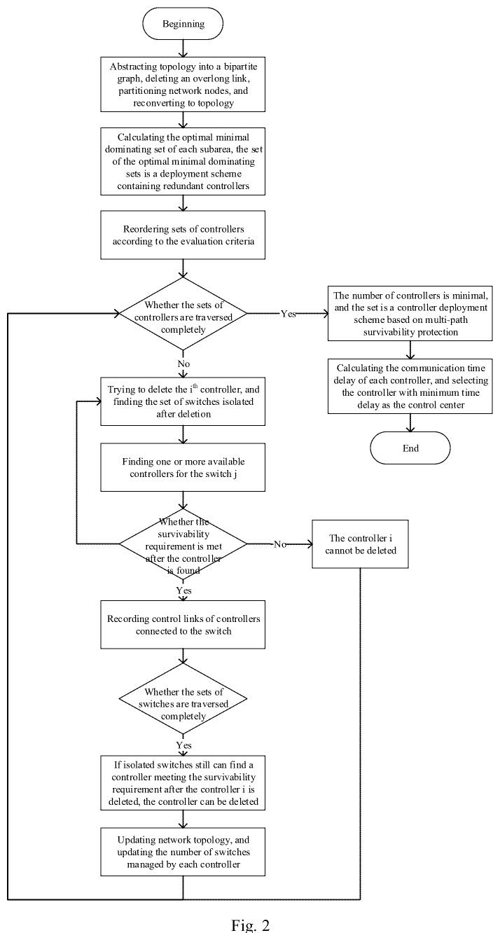

As shown in FIG. 2, a software defined optical network controller deployment method based on multi-path survivability protection, which is applied to the deployment of layer 2 SDN controllers, comprising the following steps:
Step 1: calculating the length W of the longest control link under a single controller according to the probability P specified by a user to ensure the survivability of network topology.
Step 2: calculating the shortest path Lᵢⱼ between switches V by using the Floyd algorithm, taking Lᵢⱼ as the weight of connection between Vᵢ and Vⱼ, and converting SDON network topology to a complete bipartite graph. Deleting any link with Lᵢⱼ>W, ensuring that the length of each feasible path is less than W, and forming a new bipartite graph G.
Step 3: reconverting G to network topology, distributing switches with feasible paths to the same area, forming a set {φ₁, φ₂, . . . , φₙ}, and calculating a set {θᵢ₁, θᵢ₂, . . . , θᵢₙ} of optimal minimal dominating sets in Pt. The deployment position of the minimal dominating set is the deployment scheme of a single controller. Thus, a deployment scheme containing redundant controllers is obtained and represented by a set {C₁, C₂, . . . , Cₙ}.
Step 4: reordering controllers in the set {C₁, C₂, . . . , Cₙ} to obtain a new set {C′₁, C′₂, . . . , C′ₙ}, and trying to delete the controller C′₁.

Step 5: when C′₁ is no longer used as a controller, representing isolated switches by a set {S₁, S₂, . . . , Sₙ}. Finding currently available controllers for Sᵢ by using the corrected Floyd algorithm.
Step 6: judging whether Sᵢ can achieve the network survivability after being linked to a new controller by using the calculation formula of the network fault probability under multiple controllers. If all switches in the set {S₁, S₂, . . . , Sₙ} find satisfactory controllers and control links, the controller C′₁ can be deleted, and the new controller is added to a set {V_{pc1}, V_{pc2}, . . . , V_{pcn}}; otherwise, C′₁ cannot be deleted, and C′₁ is added to the set {V_{pc1}, V_{pc2}, . . . , V_{pcn}}.
Step 7: after discussing C′1, repeating steps 4, 5 and 6 until all controllers in the set {C′₁, C′₂, . . . , C′ₙ} are discussed. The set {V_{pc1}, V_{pc2}, . . . , V_{pcn}} is an SDON controller deployment scheme based on multi-path survivability protection.
Step 8: determining the deployment position of the control center V_{cc} based on coordinated signaling transmission time delay between the controllers.

The maximum length L of the control link is calculated according to the formula

$$W = \frac{ln ( 1 - P )}{ln ( 1 - ρ )} ,$$

wherein P is the maximum fault probability acceptable to the user, and p is the fault probability per 100 km of optical fibers. Then SDN switch nodes are abstracted into a complete bipartite graph, the minimum path length between the nodes is taken as the weight of the bipartite graph, and links with the weight larger than L are deleted from the bipartite graph. Reachable nodes in the bipartite graph are distributed to the same area, and network topology is reconverted.

The optimal minimal dominating set of each subarea is found, and the set of minimal dominating sets is a deployment scheme containing redundant controllers. The sets of controllers are reordered from small to large based on the number of switches controlled by the controllers, and whether each controller can be deleted from the set is judged. Under the condition of achieving the survivability, the deployment cost of the controllers is reduced.

The procedure for judging whether each controller can be deleted is the same. The switches isolated after deletion of controllers, including switches previously managed by the controllers and the controllers, are stored in a set S. To ensure that the network topology meets the survivability requirement, it is necessary to find one or more controllers for each switch in the set S, and the fault probability is lower than P.

The fault probability P′ of the isolated switches is calculated according to the formula P′=Πᵢ₌₁ⁿ[1−(1−ρ)^{L}^{ᵢ}]. If P′ of each isolated switch is lower than P, the survivability requirement of the control plane still can be ensured after deletion of the controller. Lᵢ represents the length of the i^{th} control link of the switch, and control links connected to the same switch shall not have multiple edges.

To minimize the deployment number of controllers, the switch shall tend to be connected to a controller with a larger M value. With the corrected Floyd algorithm, the isolated switches constantly find the shortest path from the switch with a larger M value. If P′ of the switch is lower than P when a new link is found, the survivability requirement is met; and if P′ is still higher than P when the last link is found, the switch cannot meet the survivability requirement, i.e., the switch cannot be deleted.

A controller deployment scheme obtained after the redundant controllers are deleted is a controller deployment scheme based on multi-path survivability protection. The control center has the function of cooperative management on the controllers. If the control center is deployed in an improper position, the time for part of nodes in the SDON network to obtain control signaling will be too long, and the network performance will degrade dramatically. Therefore, coordinated signaling transmission time delay between the controllers is taken as the primary goal, and a node with minimum average interaction time delay to deployment nodes of other regional controllers is selected as the centralized node. A controller with minimum communication time delay is selected as the control center deployment position according to the formula Tᵢ=avgΣⱼ₌₁ⁿ⁻¹T(Vᵢ, Vⱼ).

It should also be noted that terms of “comprise”, “include” or any other variant are intended to cover non-exclusive inclusion, so that a process, a method, an article or a device which includes a series of elements not only includes such elements, but also includes other elements not listed clearly or also includes inherent elements in the process, the method, the article or the device. Under the condition of no more limitation, the elements defined by a sentence “include one . . . ” do not exclude additional identical elements in the process, the method, the article or the device which includes the elements.

The above embodiments shall be understood to be only used for illustrating the present invention, not used for limiting the protection scope of the present invention. The technical personnel can, after reading the content recorded in the present invention, implement various modifications to and variations of the present invention, and such equivalent changes or modifications also fall within the scope defined by claims of the present invention.

1. A software defined optical network controller deployment method based on multi-path survivability protection, characterized by comprising the following steps:
step 1: calculating the length W of the longest control link under a single controller according to the probability P specified by a user to ensure the survivability of network topology;
step 2: calculating the shortest path Lᵢⱼ between switches V by using the Floyd algorithm, taking Lᵢⱼ as the weight of connection between Vᵢ and Vⱼ, and converting SDON network topology to a complete bipartite graph; and deleting any link with Lᵢⱼ>W, ensuring that the length of each feasible path is less than W, and forming a new bipartite graph G;
step 3: reconverting G to network topology, distributing switches with feasible paths to the same area, wherein the topology is usually divided into n areas, and a switch in the i^{th} area is represented by φᵢ, forming different areas into a set {φ₁, φ₂, . . . , φₙ}, and calculating a set {θᵢ₁, θᵢ₂, . . . , θᵢₙ} of optimal minimal dominating sets in φᵢ, wherein n represents the number of switches in the minimal dominating set; and the deployment position of the optimal minimal dominating set is the deployment scheme of a single controller, and a deployment scheme containing redundant controllers is obtained and represented by a set {C₁, C₂, . . . , Cₙ};
step 4: reordering controllers in the set {C₁, C₂, . . . , Cₙ} from small to large based on the number of switches under respective control to obtain a new set {C′₁, C′₂, . . . , C′ₙ}, and trying to delete the controller C′₁;
step 5: when C′₁ is no longer used as a controller, representing isolated switches by a set {S₁, S₂, . . . , Sₙ}; and finding k (k≥2) new control links for Sᵢ by using the Floyd algorithm, wherein the Floyd algorithm is used for finding the shortest path from Sᵢ to other nodes, and appropriate control links and the number thereof are selected so that the network fault probability meets the survivability requirement;
step 6: judging whether Sᵢ can achieve the network survivability after being linked to a new controller by using the calculation formula of the network fault probability under multiple controllers; if all switches in the set {S₁, S₂, . . . , Sₙ} find satisfactory controllers and control links, the controller C′₁ can be deleted, and the new controller is added to a set {V_{pc1}, V_{pc2}, . . . , V_{pcn}}; otherwise, C′₁ cannot be deleted, and C′₁ is added to the set {V_{pc1}, V_{pc2}, . . . , V_{pcn}};
step 7: after operation of C′₁, repeating steps 4, 5 and 6 until the operation of all controllers in the {C′₁, C′₂, . . . , C′ₙ} is completed, and the set {V_{pc1}, V_{pc2}, . . . , V_{pcn}} is an SDON controller deployment scheme based on multi-path survivability protection;
step 8: determining the deployment position of the control center V_{cc} based on coordinated signaling transmission time delay between the controllers.

2. The software defined optical network controller deployment method based on multi-path survivability protection as claimed in claim 1, characterized in that the step of calculating the shortest path Lᵢⱼ between switches V by using the Floyd Shortest Path Algorithm in step 2 specifically comprises: representing the shortest distance between Vᵢ and Vⱼ by M[i, j], wherein k is a possible intermediate point between i and j, updating the entire matrix, i.e., the path length from i to j, and when the intermediate point is k, traversing all the possible intermediate points to obtain a globally optimal shortest path.

3. The software defined optical network controller deployment method based on multi-path survivability protection as claimed in claim 1, characterized in that the calculation formula of the length of the longest control link is:
$$W = \frac{ln ( 1 - P )}{ln ( 1 - ρ )} ,$$
the maximum length L of the control link is calculated, wherein P is the maximum fault probability acceptable to the user, and p is the fault probability per 100 km of optical fibers; and then SDN switch nodes are abstracted into a complete bipartite graph, the minimum path length between the nodes is taken as the weight of the bipartite graph, links with the weight larger than L are deleted from the bipartite graph, reachable nodes in the bipartite graph are distributed to the same area, and network topology is reconverted.

4. The software defined optical network controller deployment method based on multi-path survivability protection as claimed in claim 1, characterized in that the conditions for determining the optimal minimal dominating set in step 3 are as follows: the minimal dominating set with the smallest number of nodes is selected as the optimal minimal dominance set in the area to reduce the deployment cost of controllers; and if multiple satisfactory minimal dominating sets exist, a minimal dominating set with the largest sum of degrees of the nodes in the set, thereby improving the control redundancy of the control plane while minimizing the deployment cost.

5. The software defined optical network controller deployment method based on multi-path survivability protection as claimed in claim 1, characterized in that in step 4, the currently optimal set {C₁, C₂, . . . , Cₙ} ordering method is selected by referring to the greedy algorithm;
the number of switches controlled by controllers is taken as the evaluation criteria; wherein the controllers controlling less switches have less impact on the control plane if deleted, are easier to delete, and thus are ranked ahead; and therefore, the sets are reordered from small to large based on the number of switches controlled by the controllers to obtain a set {C′₁, C′₂, . . . , C′ₙ}.

6. The software defined optical network controller deployment method based on multi-path survivability protection as claimed in claim 1, characterized in that in step 5, no redundancy protection path is considered between switches and controllers, i.e., only one control path exist; and the corrected Floyd algorithm is used for finding N controllers for Sᵢ, and control links between the N controllers and Sᵢ do not have multiple edges.

7. The software defined optical network controller deployment method based on multi-path survivability protection as claimed in claim 1, characterized in that in step 6, the network fault probability of the control plane of switches under multiple controllers is calculated according to formula (1), wherein P′ represents the fault probability after an isolated switch node Sᵢ is connected to a new controller, a set {L₁, L₂, . . . , Lₙ} represents the length of control links not having multiple edges between Si and the N controllers, and Li represents the length of the i^{th} control link; and according to the formula, it can be considered that Si can achieve the survivability required by the user after being connected to the new controller so long as P′<P;
P′=Πᵢ₌₁ⁿ[1−(1−ρ)^{L}^{ᵢ}] (1)

8. The software defined optical network controller deployment method based on multi-path survivability protection as claimed in claim 1, characterized in that in step 8, in consideration of coordinated signaling transmission time delay between the controllers, the V_{cc} node is deployed at the node Tₘᵢₙ=min{T₁, T₂, . . . , T₃} with minimum average interaction time delay to the controller deployment node, wherein T(Vᵢ, Vⱼ) represents interaction time delay between nodes Vᵢ and Vⱼ, and Tᵢ represents average interaction time delay between Vᵢ and other nodes;
Tᵢ=avgΣⱼ₌₁ⁿ⁻¹T(Vᵢ,Vⱼ) (2)
